(19) United States
(12) Patent Application Publication
(10) Pub. No.: US 2017/0337575 A1
(43) Pub. Date: Nov. 23, 2017

(54) SYSTEMS AND METHODS USING CONSUMER PARTICIPATION IN ASSOCIATION WITH AN EVENT TO EFFECT THE ALLOCATION OF CREDIT TO SERVICE PROVIDERS

(71) Applicants: Michael W. Shore, Dallas, TX (US); Samir Varma, Greenwich, CT (US); Luis M. Ortiz, Albuquerque, NM (US)

(72) Inventors: Michael W. Shore, Dallas, TX (US); Samir Varma, Greenwich, CT (US); Luis M. Ortiz, Albuquerque, NM (US)

(21) Appl. No.: 15/602,843

(22) Filed: May 23, 2017

Related U.S. Application Data
(60) Provisional application No. 62/340,341, filed on May 23, 2016.

(51) Int. Cl. G06Q 30/02; H04W 4/02

(52) U.S. Cl. CPC G06Q 30/0226; H04W 4/02

(57) ABSTRACT

Data collected from consumers (e.g., sports fans, spectators, gamers, shoppers) based on their participation associated with an event (e.g., a sporting event, a broadcasted show, an online contest, shopping) can be used to effect the allocation of credit (e.g., points, ratings, fees, money, equity) to select service providers (e.g., sports teams, sport team members, sports team coaches, shows, actors, video game competition, providers of highlighted products at a shopping center, a particular store). Data can be in the form of profile information, location, and input/feedback regarding an event. Data can be collected from a portable electronic device (e.g., smartphone) used by consumers. Feedback can be provided to consumers. Participation associated with an event can be by consumer attendance at an event as determined by portable electronic device location information. Participation can also be provided in the form of consumer input on a user interface associated with their portable electronic device.

### CROSS REFERENCE TO RELATED PATENT APPLICATIONS

This patent application claims the priority and benefit of U.S. provisional patent application 62/340,341, entitled “SYSTEMS AND METHODS USING CONSUMER PARTICIPATION IN ASSOCIATION WITH AN EVENT TO EFFECT THE ALLOCATION OF CREDIT TO SERVICE PROVIDERS,” filed on May 23, 2016. This patent application therefore claims priority to U.S. Provisional Patent Application Ser. No. 62/340,341, which is incorporated herein by reference in its entirety.

### TECHNICAL FIELD

The embodiments are generally related to data collection and its use to influence an outcome. More particularly, embodiments are related to the use of data collected from consumers, based on their participation in association with an event, to effect the allocation of credit to service providers and influence them.

### BACKGROUND

Big data has become omnipresent and important in decisions by businesses, governments, entertainment entities, and, more recently, consumers. For example, consumer can research products and obtain associated ratings online before committing to a purchase. The ubiquity of portable handheld devices has only increased the demand and expectation for data by all users. Data will continue to influence business and consumers, and more importantly, will be obtained from consumers to influence service providers. What are needed are methods and systems for obtaining data from consumers for processing in a manner that can assist and influence service providers.

### BRIEF SUMMARY

In accordance with a preferred embodiment, it is a feature that data collected from consumers (e.g., sports fans, spectators, gamers, shoppers) based on their participation associated with an event (e.g., a sporting event, a broadcasted show, an online contest, shopping) can be used to effect the allocation of credit (e.g., points, ratings, fees, money, equity) to service providers (e.g., sports teams, sport team members, sports team coaches, shows, actors, video game competition, providers of highlighted products at a shopping center, a particular store).

It is another features of the embodiments that data collected from consumers can be in the form of profile information, location information, and input/feedback regarding an event.

It is yet another feature of the embodiments that data can be collected from a portable electronic device (e.g., smartphone, tablet computer) used by consumers.

It is also a feature of the embodiments that participation associated with an event can be by the consumers physically attending an event as determined by location information obtained from the consumers' portable electronic devices in the form of GPS location information, cellular signal triangulation, and Wi-Fi router/hotspot network internet protocol (IP) address information registering with the portable electronic device.

It is another feature of the embodiments that participation can also be provided by the consumer in the form of input on a user interface associated with their portable electronic device and into an application running on the portable electronic device or a remote server that is associated with the event.

It is another feature of the embodiments that feedback can actively be provided to consumers regarding their participation in or interest in an event.

It is a feature of the embodiments that the allocation of credit can be by percentages or specific amounts as determined by select parameters from a credit allocation algorithm running on a remote server.

It is also a feature of the embodiments that effecting the allocation of credit (e.g., points, ratings, fees, money, equity) to service providers can be in the form of the users' fees between the teams, or two “sides” of the event based on the data collected from consumers (e.g., consumer input in favor of a particular team, player, coach in a broadcasted sporting event).

It is also a feature of the embodiments that effecting the allocation of credit (e.g., points, ratings, fees, money, equity) can be used by an algorithm running in a server to produce data for service providers to use as input in making a business determination (e.g., fan input in favor of a particular team, rating a player or draft choice, rating coaches).

It is another feature of the embodiments that an algorithm can include data from vetted consumers (e.g., top fans, credible sources, valued customers) as a parameter together with other parameters (e.g., team owner input, coaching staff input) for producing a recommendation for service providers.

### BRIEF DESCRIPTION OF THE DRAWINGS

FIG. 1 illustrates a flow diagram of method steps in accordance with the embodiments;

FIG. 2 illustrates a system diagram in accordance with features of the embodiments;

FIG. 3 illustrates a schematic view of a computer system, in accordance with an embodiment; and

FIG. 4 illustrates a schematic view of a software system including a module, an operating system, and a user interface, in accordance with an embodiment.

### DETAILED DESCRIPTION

Described are methods and systems for obtaining data from consumers for processing in a manner that can assist or influence service providers.

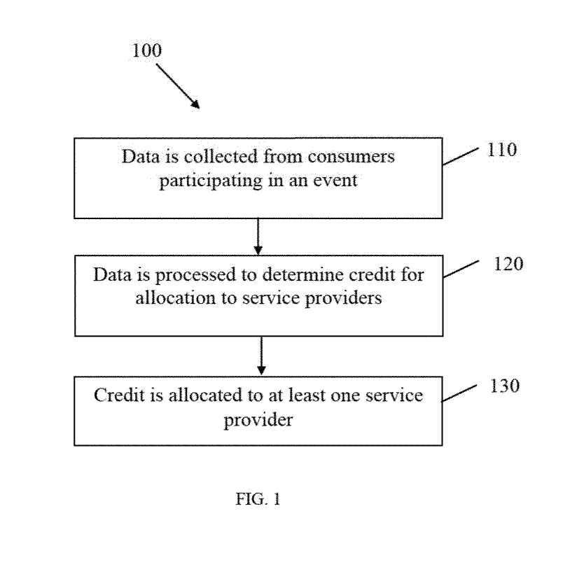

Referring to the flow diagram 100 in FIG. 1, data is collected from consumers participating in an event as shown in block 110. Data representing consumer participation in an event can be in the form of consumer profile information, consumer location information, and input/feedback from consumers regarding an event. Consumers can include any of: sports fans, spectators, gamers, and shoppers. Next, as shown in block 120, the data is processed to determine credit for allocation to service providers. Then as sown in block 130, credit is allocated to at least one service provider. An event can include any of: a sporting event, a broadcasted show, an online contest, and shopping including online or at a physical facility (e.g., a mall). Credit can include any of: points, ratings, fees, money, and equity. Select service providers can include any of: sports teams, sport team members, sports team coaches, shows, actors, video game competitions, video game competitors, providers of highlighted products at a shopping center, a particular store.

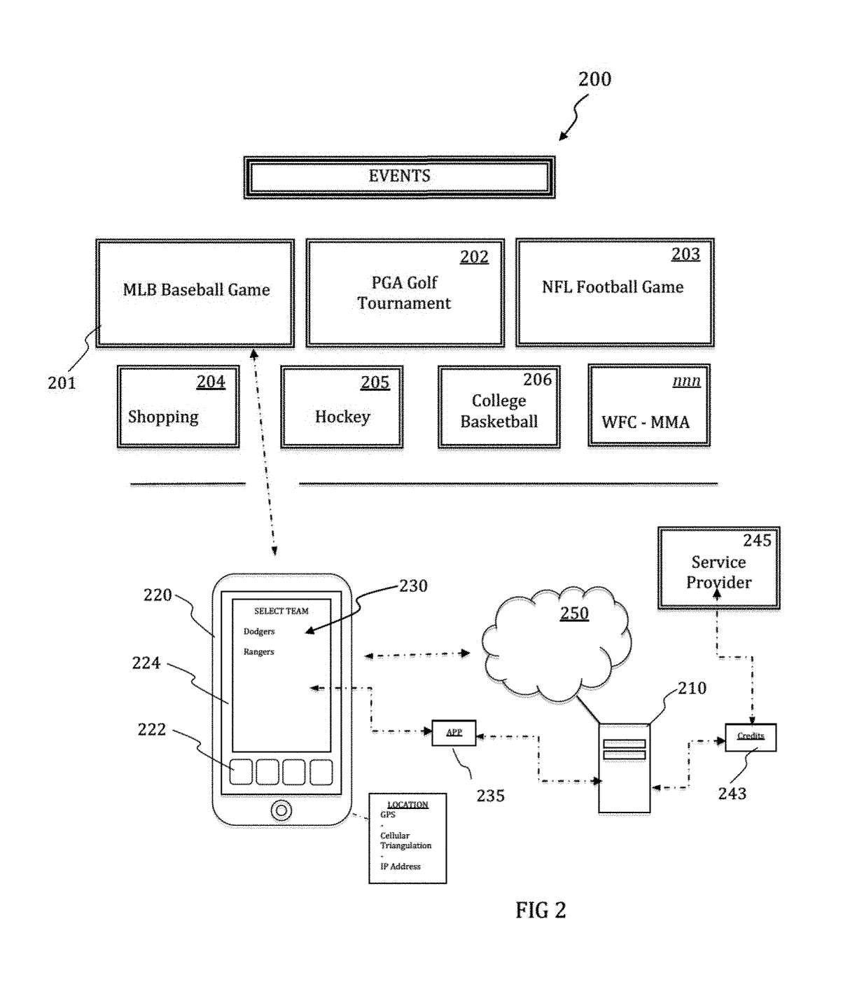

Referring to the system diagram 200 in FIG. 2, data 230 can be collected by a server 210 over a data network 250 from a portable electronic device 220 (e.g., smartphone, tablet computer) being used by consumers participating in an event 201. The event shown for participation in the figure is a Major League Baseball (MLB) game and is for exemplary purposes only. Participation associated with an event can be by a consumer physical attending an event 201 as determined by location information 225 obtained from the consumer's portable electronic device 220 in the form of GPS location information, cellular signal triangulation, network internet protocol (IP) address information supporting communication of the portable electronic device 220. Participation can also be provided by the consumer in the form of input on a user interface 222 as part of a touch sensitive display screen 224 associated with their portable electronic device 220 and into an application 235 (“App”) running on the portable electronic device 220 or a remote server 210 and which is associated with the event 201. Allocation of credit 243 to service providers 245 associated with an event 201 can be by percentages or specific amounts as determined by select parameters from a credit allocation algorithm running on a remote server. Effecting the allocation of credit (e.g., points, ratings, fees, money, equity) to service providers 245 can be in the form of the users' fees between the teams, or two “sides” of the event based on the data collected from consumers (e.g., consumer input in favor of a particular team, player, coach in a broadcasted sporting event).

What follows are examples of how the embodiments can be applied. The examples are not meant to limit the scope of the embodiments for the present invention. SMU can join a major conference and not take an equal share of revenue, but instead earn their way in as their brand becomes more valuable as a draw for pay-per-view viewers. Value of the participation of each team can be determined using fan metrics and a decision tree.

Since sports entities may know whom the most engaged fans are and are also likely to know who the most knowledgeable fans are, the present systems and methods can differentially price services to them. So, not only can sports entities have different offers for different types of fans, but they can also have different ticket prices for those specific fans. Normally tickets are transferable (which leads to price leaks), but by putting these tickets on an “app” they can be made non-transferable. Since they're non-transferable, they can also be prevented from leaking from the specially priced to the general public.

Teams could adjust their general attendance demographic. So, if, for example, the Miami Dolphins are playing the NY Jets in Miami, and there are way too many Jets fans coming (i.e., not enough team support), the Miami Dolphins organization could send offers to Dolphins fans to come to the stadium and balance out the Jets fans. And an organization could furthermore also pick the type of fan it wants at the event, where they will be seated for maximum noise, and whether to seat them together or spread them out, etc.

The other thing you can do is to raise ticket prices for some people, while lowering it for others, based on their marginal propensity to pay. Economists have also called this price discrimination. For example, consider why popcorn is so expensive at a movie theatre. It turns out that people that love movies more and thus would be willing to pay more for a movie ticket are roughly also the same people that like to eat popcorn at the movies. Theater owners effectively charge those people more for their ticket: market segmentation via popcorn! In the sports venue ticketing case, teams can segment the market and thus increase their own profits. It can be appreciated that a system can be employed to make differently priced tickets “look different” so that people don't complain about paying different prices for the same thing—the key is to find those populations that will pay more and charge them more and those that will pay less and charge them less, without having the two groups overlap. Or, if it's college sports, find those donors that are likeliest to donate large amounts, and so on.

The embodiments are not just restricted to sports. Imagine that one of the major fashion houses launches a new line that is exclusive to Nordstrom. It's such a big deal that Nordstrom gets lots of new traffic. How can that fashion house be compensated for the extra traffic it brings to Nordstrom? That can now be measured with implementation of the present embodiments. The fashion house can release an app that contains offers that only select consumers can redeem if location tracking is active on their mobile devices while inside Nordstrom. Now the retailers can know exactly where that shopper went within a mall, e.g., Nordstrom, which means a fair split can be calculated of the extra revenue Nordstrom receives from that shopper coming to see the new fashion line, and then quite naturally wandering about in the store or mall making additional purchases.

The principle is: if party A can segment a market via engagement information, then closing the loop means that Party A can benefit both itself AND/OR its affiliates. Party A can segment any market—it doesn't necessarily have to segment its own market though that's most likely. For example, perhaps SMU fans of a certain type segment are also those that would be most interested in travel offers from Abercrombie & Kent versus those of a different segment that don't. Fans can get their teams more money or other benefits by enabling their fans to watch, report, and provide feedback. With the present embodiments, the fan can literally be part of the team; and the more they are, the more advertisers know they are getting the impact they want. By closing the feedback loop, data becomes more useful. Consumers (e.g., the viewers of a sporting event) will know that their input is going to affect a service provider (e.g., a team's revenue).

As another sporting example, if more than a certain number of viewers fitting a certain profile watch a certain number of hours of their sports team, the team can get an extra draft pick. Each team can then encourage its viewers to watch by telling them that their team will get better (via draft picks) if they watch their events. Similarly, extra points can go to the team for the viewers that don't skip ads versus the viewers that do.

Location tracking can be an important aspect for certain embodiments. Because more consumers have a smartphone, consumers (e.g., sports fans) can opt in to be “tracked” during events (e.g., games). If they go to a viewing party, which can be checked from the smartphone's location, or through a smartphone's microphone by identifying what is on a television set by the sound, the team can get extra draft picks or something else of value.

Consumers can be asked to fill in detailed demographic profiles, and link those to both their smartphone and their web accounts with an event or their team. The carrot is that if more than a certain number of fans fill in the detailed profile, the service provider (e.g., team) can get additional credit allocated. For a professional sports team, additional credit allocation can improve its revenue cap or provide it with more draft picks.

For sporting events, the fans that are most dedicated to watching their teams (whether on TV or in person at the stadium) could be given the opportunity to buy exclusive things of tangible value. For example, in the NFL, teams can never have enough eyes watching plays. Teams can ask their most dedicated fans for feedback—what plays worked, why, which blocking techniques, which defensive back played best and why, etc. In other words, a team can have “smart” crowdsourcing as opposed to just crowdsourcing. The NFL already sells additional cost packages to the fans called “all 22” where you can see all 22 players on the field—it's what the coaches' see. There are enough fans that would be willing to buy the right to give their suggestions to the team.

A team could also offer up its most dedicated fans a live poll during draft day where those most dedicated fans could continuously vote on which player they want picked (or trade the pick) as the draft goes on. Again, very valuable feedback to an open-minded coach.

Fan grading can be so useful and so accurate that NFL coaches, for example, could adopt the input and use it to identify the “best” fans, which are also the most “knowledgeable,” and then there can be numerous opportunities to make use of their best fans' collective wisdom. For example, who knows how good Tony Romo really is? The collection of people that watched every single game that Romo ever played likely would. Similarly, decisions on who to draft possess a huge opportunity that can be “crowdsourced” this way. The key point is that teams can be asking only those people that might actually know what they're talking about for input. This input could also be used for determining compensation. How much to pay various coaches and the amount of playing time or compensation players get could be partially determined by how the most dedicated fans feel about them. Similarly, teams could offer other stuff of real value to their most dedicated fans: from the group of people that watched all the games and all the ads(!), you pick X that come for free to the live game, and the team pays for their hotel and takes them onto the field to meet players, and makes a big fuss about them, etc.

The advantage with having a feedback loop in association with sporting events is that it, finally, aligns everyone's interests. The advertisers actually get more eyeballs, the fans get to affect their own team, and the teams get extra revenue, better players, and help with making better decisions, etc., and it's all measurable. In the future, all major sports will be pay-per-view. It is expected to affect the “each team gets paid a fixed amount or percentage” in current TV deals, for example, Big 12 conference football. The present inventors believe that data collected from viewers in the future will be used to allocate the users' fees between the teams, or two “sides” of the event. A “side” can be binary (Team A, Team B), quadratic (Team/Conference A, Team/Conference B) or even octagonal. It can get as complex as necessary to satisfy all stakeholders that their “share” is fair to them.

When a viewer chooses the Michigan vs. SMU basketball game, an algorithm programmed in a server can use all of the data about that user (location, past buying behavior, etc.) or an input from that user (as but one factor) in deciding how to divide that $49.99. A user in Florida might have a data history that indicates they are more likely buying because Michigan is playing. That buyer's $49.99 might go 60, 70, 80 or some other % based upon the degree of likelihood that Michigan's involvement drives the purchase. Buyer A: 3,597 data points, all individually weighted relative to one another, reveals he is a SMU fan, his fan status is most related to the new coach (he never watched before, but watched team x when coach was there) to the point that you can use that to calculate shares. A service can also have a user declare his team when he buys tickets or other team-related goods and services, but that is just another data point. He may declare SMU fan status, but he only pays when SMU plays certain types of teams, of which Michigan may be that type.

The embodiments can therefore enable the basing of credit allocation on predictive/diagnostic factors to determine the basis of third party decision making, and can be executed in a manner that all participants agree is a fair way to allocate credit (e.g., divide credit/revenue).

It can be important that input is provided, or used, from only the most credible parties. For example, fans that the system can identify as credible may be season ticket holders, regular contributors, etc., as opposed to a contribution from a limited or one-time use. In a sports application, fan engagement will be important to obtain and assess. “Engagement” can be defined using a metric. For exemplary purposes, assuming an engagement with SMU fans, then, (1) a direct segmentation would be that the most “engaged” SMU fans are also likely to be bigger donors and may be receptive to a donation pitch, and (2) an indirect segmentation would be that the most engaged SMU fans would be receptive to offers from high-end Brazilian Churrascarias, whereas the less engaged would prefer offers for tailored clothing. The engagement metric could be single valued (one number) or multi-valued (more than one number—this could be thought of as multiple engagement metrics). Similarly, the segmentations could be divided into two (more receptive/less receptive) or multiple segmentations (more than two).

Once obtained, data can be weighted and utilized in decision making. An algorithm can weigh input to decision making based on more than one input. For example, in a sports scenario where a decision is attempted regarding the hiring of a coach, picking a draft pick, making a salary determination, building a new stadium, etc., fan input (F) can be weighed against coach input (C) and team owner input (O). For example, a team owner might have 50%, coaching staff 30%, and fans 20%. So, a decision can be made as follows: O+C+F=Percentage. Where several potential draft picks are being considered, fans will actually take part in the ranking.

Feedback to third parties, whether in the shopping or sports scenarios, can be important in order to maintain interest and engagement in the process. Third parties can also be incentivized for participation.

As can be appreciated by one skilled in the art, example embodiments can be implemented in the context of a method, data processing system, or computer program product. Accordingly, example embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium can be utilized including hard disks, USB Flash Drives, DVDs, CD-ROMs, optical storage devices, magnetic storage devices, server storage, databases, etc.

Computer program code for carrying out operations of the present invention can be written in an object oriented programming language (e.g., Java, C++, etc.). The computer program code, however, for carrying out operations of particular embodiments can also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi Wimax, 802.xx, and cellular network, or the connection may be made to an external computer via most third party supported networks (for example, through the Internet utilizing an Internet Service Provider).

The example embodiments are described at least in part herein with reference to flowchart illustrations and/or block diagrams of methods, systems, and computer program products and data structures according to embodiments of the invention. It should be understood that each block of the illustrations, and combinations of blocks can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions can also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

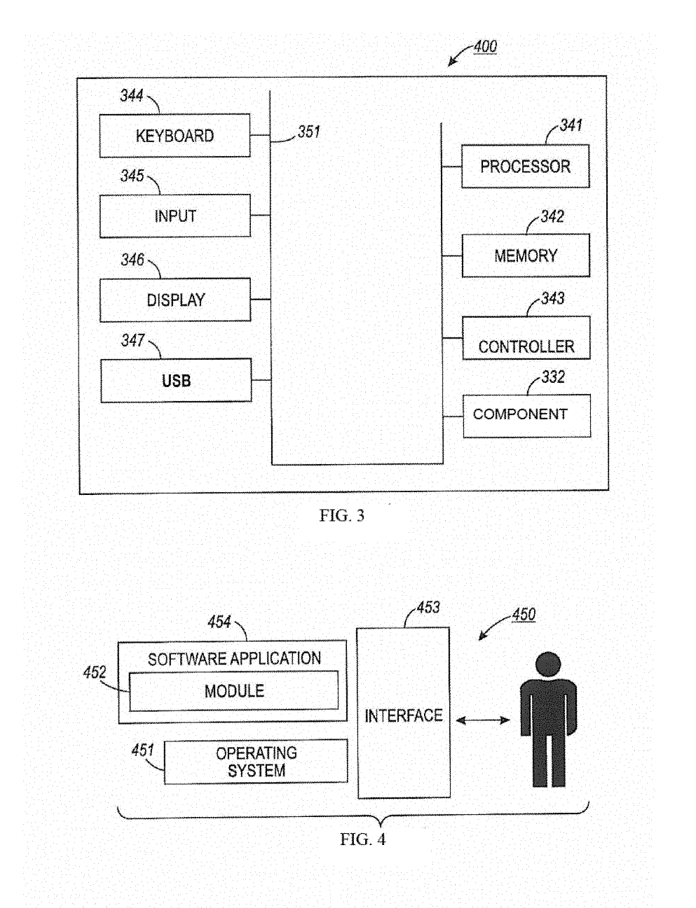

FIGS. 3-4 are shown only as exemplary diagrams of data-processing environments in which embodiments can be implemented. It should be appreciated that FIGS. 3-4 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 3, some embodiments cans be implemented in the context of a data-processing system 400 that can include one or more processors such as the processor 341, the memory 342, an input/output controller 343, a peripheral USB—Universal Serial Bus (USB) connection 347, a keyboard 344 and/or another input device 345 (e.g., a pointing device, such as a mouse, track ball, pen device, etc.), a display 346, and in some cases, a peripheral connection component 332, which may connect to other electronic components.

As illustrated, the various components of data-processing system 400 can communicate electronically through a system bus 351 or similar architecture. The system bus 351 can be, for example, a subsystem that transfers data between, for example, computer components within data-processing system 400 or to and from other data-processing devices, components, computers, etc. Data-processing system 400 can be implemented in some embodiments as, for example, a server in a client-server based network (e.g., the Internet) or in the context of a client and a server (i.e., where aspects are practiced on the client and the server). In yet other example embodiments, data-processing system 400 can be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc.).

FIG. 4 illustrates a computer software system 450 for directing the operation of the data-processing system 400 depicted in FIG. 3. Software application 454 stored, for example, in memory 342, generally includes a kernel or operating system 451 and a shell or interface 453. One or more application programs, such as software application 454, can be “loaded” (i.e., transferred from, for example, mass storage or another memory location into the memory 342) for execution by the data-processing system 400.

The data-processing system 400 can receive user commands and data through the interface 453; these inputs can then be acted upon by the data-processing system 400 in accordance with instructions from operating system 451 and/or software application 454. The interface 453 in some embodiments can serve to display results, whereupon a user may supply additional inputs or terminate a session. The software application 454 can include module(s) 452, which can, for example, implement instructions or operations such as the various operations discussed herein. Such instructions/operations (e.g., method steps) can be processed by, for example, the processor 341.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. A module can include instructions to perform certain tasks, steps or operations such as those, described herein.

FIGS. 3-4 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats-tools in the form of a high-level programming language (e.g., C, Java, Visual Basic, etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct” (e.g., that “software”—a computer program or computer-programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an embodiment, if a high-level programming language is the tool used to implement a technical disclosure in the form of functions/operations, it can be understood that, far from being abstract, imprecise, “fuzzy.” or “mental” in any significant semantic sense, such a tool is instead a near incomprehensibly precise sequential specification of specific computational-machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor (e.g., processor 341) can be arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by: (a) one or more interchained physical machines; (b) interchained logic gates configured to create one or more physical machine(s) representative of sequential/combinatorial logic(s); (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s); or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc., with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendor's piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those skilled in the art by separating the technical descriptions from the conventions of any vendor-specific piece of hardware.

In view of the foregoing, the logical operations/functions set forth in the present technical description are representative of static or sequenced specifications of various ordered-matter elements in order that such specifications may be comprehensible to the human mind and adaptable to create many various hardware configurations. The logical operations/functions disclosed herein should be treated as such and should not be disparagingly characterized as abstract ideas merely because the specifications they represent are presented in a manner that one skilled in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc., in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and/or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.: and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of“two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A. B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations can be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

1. A method of allocating credit to service providers based on consumer participation in an event associated with the service provider, comprising:
collecting data from a consumer based on the consumer's participation in association with an event;
processing the data to determine credit for allocation to a service provider based on the consumer's participation; and
allocating credit to a service provider associated with the event based on the data that is collected from the consumer.

2. The method of claim 1, wherein the consumer is at least one of: a sports fan, a spectator, a gamer, and a shopper.

3. The method of claim 1, wherein the data collected from the consumer is based on the consumer's participation associated with an event including at least one of: a sporting event, a broadcasted show, an online contest, and shopping.

4. The method of claim 1, wherein the credit includes at least one of: points, ratings, fees, money, and equity.

5. The method of claim 1, wherein the service provider is at least one of: sports teams, sport team members, sports team coaches, shows, actors, video game competitions, providers of highlighted products at a shopping center, and a particular store.

6. The method of claim 1, wherein the data can be in the form of at least one of: profile information, location, and input/feedback regarding an event.

7. The method of claim 1, wherein the data is collected from a portable electronic device.

8. The method of claim 1, wherein the participation associated with an event is by a consumer's attendance at an event as determined by location information obtained from the consumer's portable electronic device.

9. The method of claim 1, wherein participation is provided by the consumer in the form of input on a user interface associated with a portable electronic device.

10. A method of allocating credit to service providers based on consumer participation in an event associated with the service provider, comprising:
a) collecting data from a portable electronic device used by a consumer based on the consumer's participation in association with an event;
b) processing the data to determine credit for allocation to a service provider based on the consumer's participation;
c) allocating credit to the service provider based on the data collected from the consumer;
d) providing feedback data regarding the service provider and allocation of credit to the consumer; and
e) returning to step (a).

11. The method of claim 10, wherein the consumer is at least one of a sports fan, a spectator, a gamer, and a shopper; the event includes at least one of a sporting event, a broadcasted show, an online contest, and shopping; and the service provider is at least one of a sports teams, a sport team member, a sports team coach, a show, an actor, a video game competition, a provider of highlighted products at a shopping center, and a particular store.

12. The method of claim 10, wherein the credit includes at least one of: points, ratings, fees, money, and equity.

13. The method of claim 10, wherein the data can be in the form of at least one of: profile information, location, input/feedback regarding an event.

14. The method of claim 10, wherein the participation associated with an event is determined by a consumer's attendance at an event as further determined by location information obtained from the consumer's portable electronic device.

15. A system for allocating credit to service providers based on consumer participation in an event associated with the service provider, comprising:
a server including a memory and access to a data network and adapted with an algorithm stored in memory for:
collecting and storing data retrieved from consumers participating in an event, wherein the data is retrieved from portable electronic devices associated with, and in use by, the consumers and in bi-directional communication with the server via the data network; and
processing the data collected from consumers and allocating credit to a service provider based on the consumers' participation associated with the event.

16. The system of claim 15, wherein the server provides feedback data to the consumers whom are at least one of: sports fans, spectators, gamers, and shoppers.

17. The system of claim 15, wherein the event includes at least one of: a sporting event, a broadcasted show, an online contest, and shopping.

18. The system of claim 15, wherein the credit includes at least one of: points, ratings, fees, money, or equity.

19. The system of claim 15, wherein the service providers includes at least one of: sports teams, sport team members, sports team coaches, shows, actors, video game competition, providers of highlighted products at a shopping center, and a particular store.

20. The system of claim 15, wherein the data collected from consumers can be in the form of profile information, location information, and input/feedback regarding an event; and the data is collected wirelessly from portable electronic devices used by the consumers.
